(19) United States
(12) Patent Application Publication
(10) Pub. No.: US 2021/0107338 A1
(43) Pub. Date: Apr. 15, 2021

(54) MOTORIZED SUN VISOR FOR MOTOR VEHICLE

(71) Applicants: Garrett Potts, Ashland City, TN (US); Daulton Bess, Ashland City, TN (US)

(72) Inventors: Garrett Potts, Ashland City, TN (US); Daulton Bess, Ashland City, TN (US)

(21) Appl. No.: 16/600,485

(22) Filed: Oct. 12, 2019

(51) Int. Cl. B60J 3/02; H02S 20/30

(52) U.S. Cl. CPC B60J 3/0213; B60R 2011/0035; B60J 3/0282; H02S 20/30

(57) ABSTRACT

A motorized sun visor that may be disposed between the roof and headliner of a motor vehicle wherein the system may include a frame, screen, actuator, and power supply. The screen and frame may be positioned in a fully retracted position or a fully deployed position, or in an intermediate position relative to the retracted and deployed positions. The screen may be disposed such that it is non-visible when retracted and may include a leading edge which is seated flush against the headliner of the motor vehicle in the fully retracted position.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: None

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND SUMMARY

The present invention relates generally to a motorized sun visor for a motor vehicle.

More particularly, this invention pertains to a motorized sun visor that is disposed between the roof of the motor vehicle and the head liner wherein the sun visor is hidden from normal view until deployed by at least one actuator. The sun visor may include a frame and a screen that is operably driven by the at least one actuator.

Sun visors are common to many motor vehicles and are often placed adjacent to the windshield so that they can be pivoted downward to block the upper portion of a windshield while still allowing the direct viewpoint of the driver to be clear. The operation of a common sun visor can be distracting and require the driver to manually move the sun visor into an adequate position. Movement of the sun visor can require at least one hand to be taken off of the steering wheel and may require the driver to take their eyes off the road to locate the sun visor above them. These issues can leave the driver distracted and not paying attention to the road or other motor vehicles around them.

Additionally, the sun visor can be aesthetically unpleasing and take up desired head room of occupants. Large, bulky sun visors create an additional element that must be attached to the head liner and are exposed over what often is an otherwise smooth headliner that is aesthetically clean and pleasant. Sun visors can also become loose over time and droop into the sightline of the driver causing poor vision conditions.

What is needed, then, is a sun visor that takes up little headroom in the cabin, is aesthetically pleasing, and minimizes the distraction of the driver while deploying and/or positioning the sun visor when needed.

### BRIEF SUMMARY

In some embodiments, a sunshade apparatus for a motor vehicle may include a frame. The frame may include a first rigid member, a second rigid member, and an intermediate member that may be rotatably connected to the first rigid member and second rigid member.

In some embodiments, the apparatus may include a screen disposed between the first rigid member and second rigid member.

In some embodiments, the apparatus may include an actuator wherein the intermediate member may be fixedly connected to the actuator and the actuator may operably drive the frame and screen. The frame and screen may be selectively and incrementally positionable between a fully deployed position and a fully retracted position.

In some embodiments, the actuator may be connected to the intermediate member wherein the intermediate member is rotatable about the actuator connection.

In some embodiments, the intermediate member may include a first end and a second end. The first rigid member may be located closer to the first end than the second end. The second rigid member be located closer to the second end than the first end. The intermediate member may further include an axis along its length with a rotating pin and slot for rotating the first and second rigid members about the axis.

In some embodiments, the apparatus may include a motor operably connected to the actuator and in electrical communication with an on-board electrical power source of the motor vehicle. In some embodiments, the motor may be operably connected to the actuator and in electrical communication with an electric power source separate from an electrical power source of the motor vehicle.

In some embodiments, the actuator may include a plurality of actuators, each actuator of the plurality of actuators may be fixedly connected to the intermediate member.

In some embodiments, the screen may be opaque. In some embodiments, the screen may be semi-transparent.

In some embodiments, the screen may include an interior-facing surface and exterior-facing surface wherein the interior-facing surface may include a reflective panel. In some embodiments, the screen may include the exterior-facing surface having a solar panel.

In some embodiments, the apparatus may include a mount connected to the actuator and configured to be mounted to the roof of the motor vehicle. The apparatus may be disposed between the roof of the motor vehicle and a headliner. The screen may include a leading edge wherein in the fully retracted position, the leading edge is seated flush with the headliner and the remaining screen is non-visible between the roof and headliner.

### BRIEF DESCRIPTION OF THE SEVERAL VIEWS OF THE DRAWINGS

FIG. 1 is a diagrammatic view of a screen and frame of the present disclosure

FIG. 2 is a diagrammatic view of a motorized sun visor for a motor vehicle of the present disclosure.

FIG. 3a is a side view of a motor vehicle with an embodiment of a motorized sun visor of the present disclosure.

FIG. 3b is a side view of a motor vehicle with an embodiment of a motorized sun visor that is deployed of the present disclosure.

FIG. 4a is a close-up view of FIG. 3a showing an embodiment of a motorized sun visor of the present disclosure.

FIG. 4b is a close-up view of FIG. 3b showing an embodiment of a motorized sun visor that is deployed of the present disclosure.

### DETAILED DESCRIPTION

Reference will now be made in detail to embodiments of the present disclosure, one or more drawings of which are set forth herein. Unless defined otherwise, all technical and scientific terms used herein may have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

Unless specifically stated, terms and phrases used in this document should be construed as open ended as opposed to limiting. Likewise, a group of items linked with the conjunction “and” should not be read as requiring that each and every one of those items be present in the grouping unless otherwise specifically stated. Similarly, a group of items linked with the conjunction “or” should not be read as requiring mutual exclusivity among that group unless otherwise specifically stated. Furthermore, although items, elements, or components of this disclosure may be described in the singular, the plural is contemplated to be within the scope thereof unless limitation to the singular is explicitly stated. The presence of broadening words and phrases such as “one or more,” “at least,” “but not limited to,” or the like shall not be read to mean that a more narrow intention or reading is required in instances where such broadening phrases may be absent.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, one or more sections of hooks and corresponding one or more sections of loops, ribbons, laces, ropes, buttons, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

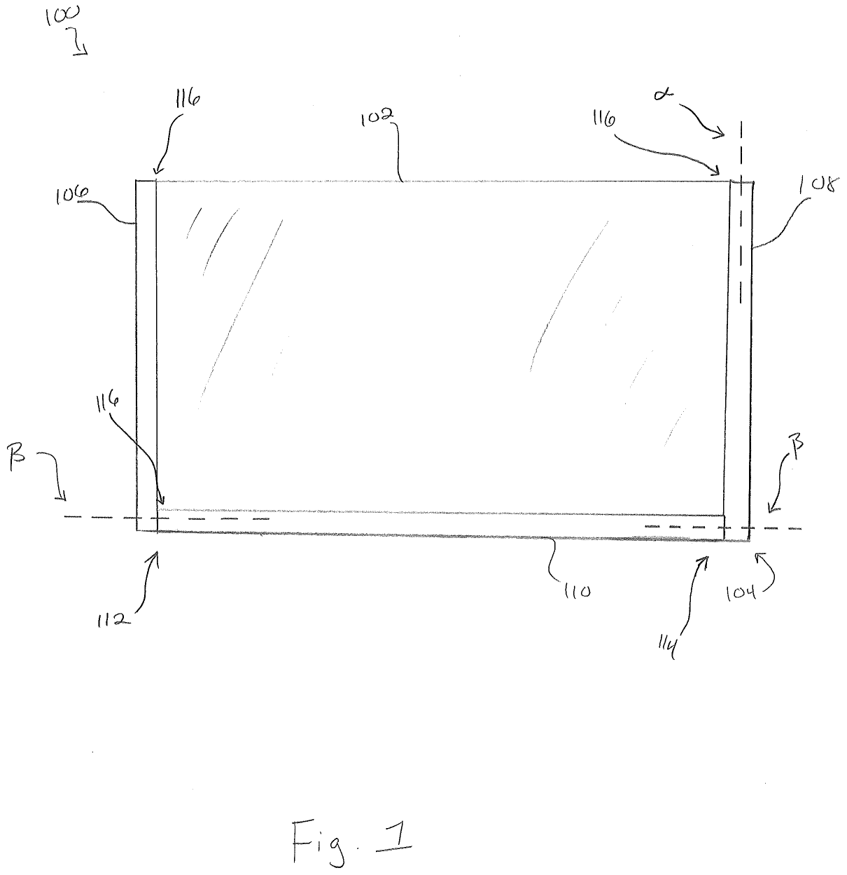

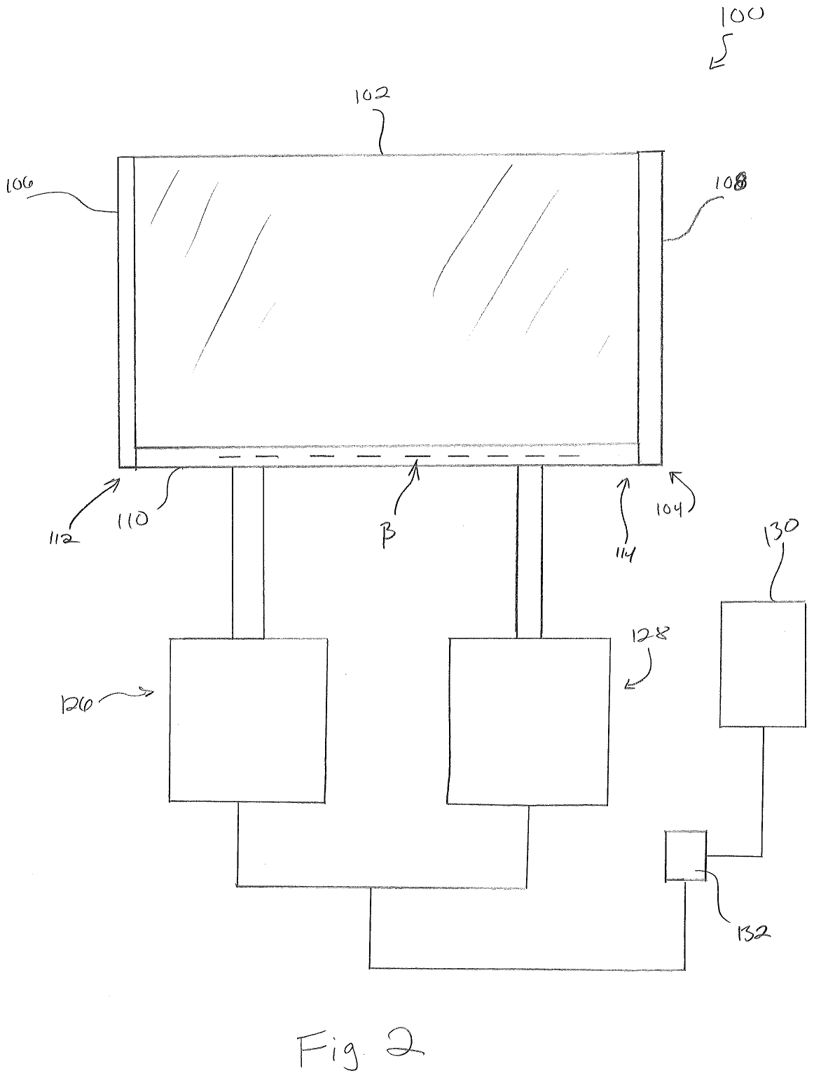

Referring now to FIGS. 1 and 2, an embodiment of the motorized sunshade 100 for a motor vehicle is shown. FIG. 1 illustrates a screen 102 that may be connected to a frame 104. The screen may be made of any appropriate material for blocking or decreasing the amount of sunlight for an occupant of the motor vehicle including, but not limited to, plastic, fabric whether woven or non-woven, leather, composites, synthetic fabrics, synthetic fibers, paper-based material, and the like. Similarly, the frame 104 and its component parts may be made of any appropriate material including, but not limited to metal, alloy, plastic, polymer, composites, and the like. Additionally, the component parts of the frame may have a cross section of any suitable shape including but not limited to circular, oval, round, square, trapezoidal, and the like. It will be understood that some embodiments may require particular shapes of components to be compatible with other components and still function as necessary based on the following disclosures.

The frame 104 may include a first member 106 and a second member 108. In some embodiments, the first and second members 106, 108 may be substantially parallel to each other and may further be located on opposing sides of the frame 104 generally. As used herein regarding the first and second members 106, 108, substantially parallel is defined wherein the first member is no greater than 5 degrees from parallel in relation to the second member's longitudinal axis, a.

In some embodiments, the first and second members 106, 108 may be rigid such that minimal deflection occurs. The rigidity of the members 106, 108 and the frame in general allows for the screen 102 to be easily positioned and remain in place. It will be understood by those skilled in the art that the first and second members 106, 108, and the frame generally, may be made of a material that exhibits a Young's modulus of at least 10 GPa. In some embodiments, the rigidity may be at least 50 GPa. In other embodiments, the rigidity may be at least 100 GPa.

In some embodiments, it may be desired to have a frame 104 that is rigid, but also is lightweight to reduce the load required to drive the frame. As such, materials such as titanium, magnesium, aluminum, carbon fiber, carbon composites, or graphene may be utilized. Materials, including, but not limited to those recited, may be lighter than steel, but have similar are greater rigidity than that of steel according to their respective Young's Modulus. In some embodiments, it will be understood that materials such as graphene may include a Young's Modulus of 1000 GPa or greater.

In some embodiments, it may be advantageous for the first and second members 106, 108 to be flexible to allow for the frame 104 to conform to the angle of the windshield of a motor vehicle or to allow the frame 104 to be more adaptable to fit in a wider variety of motor vehicles. Some metals, alloys, plastics, and composites may provide the necessary flexibility where the Young's modulus of the material is less than 10 GPa. In some embodiments, the material may be less than 1 GPa.

FIGS. 1 and 2 also illustrate an embodiment of the frame 102 which includes an intermediate member 110. The intermediate member 110 may be disposed between the first 106 and second 108 members. In some embodiments, the intermediate member 110 may include a first end 112 and a second end 114. The first member 106 may be connected to the intermediate member 110 at a position that is closer to the first end 112 than the second end 114. The second member 108 may be connected to the intermediate member 110 at a position that is closer to the second end 114 than the first end 112.

In some embodiments, the intermediate member may be rotatably connected to the first and second members 106, 108. This configuration may allow for the screen 102 to be selectively positioned at a given angle desired by the occupant of the motor vehicle. The first member 106 and second member 108 may be rotated about the longitudinal axis β of the intermediate member 110. In some embodiments, each of the first and second members 106, 108 may be connected to the intermediate member 110 via a rotating pin joint. In other embodiments, each of the first and second members 106, 108 may be connected to the intermediate member 110 via a rotating pin and slot joint. In some embodiments, each of the first and second members 106, 108 may be connected to the intermediate member via a bushing and retainer mechanism, or a bearing mechanism. One of skill in the art will readily understand that various rotatable mechanisms may be employed to allow rotation of the first member 106 and second member 108 to rotate about the longitudinal axis β of the intermediate member 110.

Referring to FIG. 1, a screen 102 may be disposed between the frame 104 and its components. In some embodiments, the screen 102 may be disposed between the first member 106 and second member 108. In certain embodiments, the first member 106 and second member 108 may include a slotted channel 116 which may allow the screen 102 to be disposed in the channel and connected to each of the first and second members 106, 108. A similar slotted channel 116 may also be included in the intermediate member 110 such that the screen 102 is connected to the intermediate member in a similar fashion. In other embodiments, the screen 102 may have channels defined in the fabric or may have each end doubled-over such that a channel is created and therefore may allow for the frame components to be disposed therein.

In some embodiments, the frame 104 may be completely encompassed within the screen 102 such that no component of the frame can be seen. This configuration may provide an advantage that creates a better aesthetic and cleaner overall look of the device 100 such that the only visible part to an occupant is the screen 102. In other embodiments, a portion or all of the frame components may be visible with the screen 102 attached thereto.

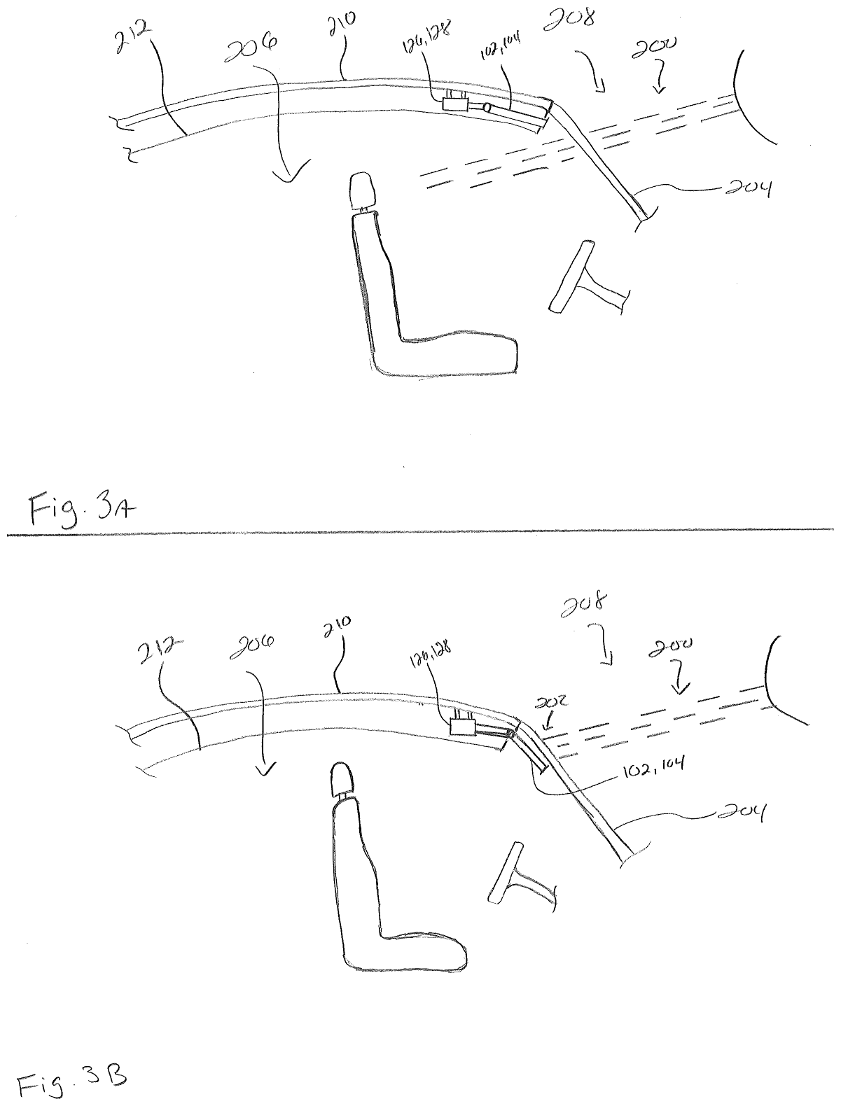

The screen 102 may be selectively and incrementally positionable so that sun radiation 200 may be blocked 202, at least partially, from the view of the occupant of the motor vehicle, as shown in FIGS. 3a and 3b. In some embodiments, the screen 102 may be opaque such that no sun radiation 200 is transmitted through the screen 102. In other embodiments, the screen 102 may be semi-transparent such that some portion of the sun radiation 200 may pass through the scree 102. In some semi-transparent embodiments, at least 50%-99% of the sun radiation 200 is not transmitted through the screen 102. In some embodiments, 60%-80% of the sun radiation 200 is not transmitted through the screen 102. In some embodiments, 70-75% of the sun radiation 200 is not transmitted through the screen 102. In some embodiments, the screen 102 prevents 72.5% of sun radiation 200 from passing through the screen.

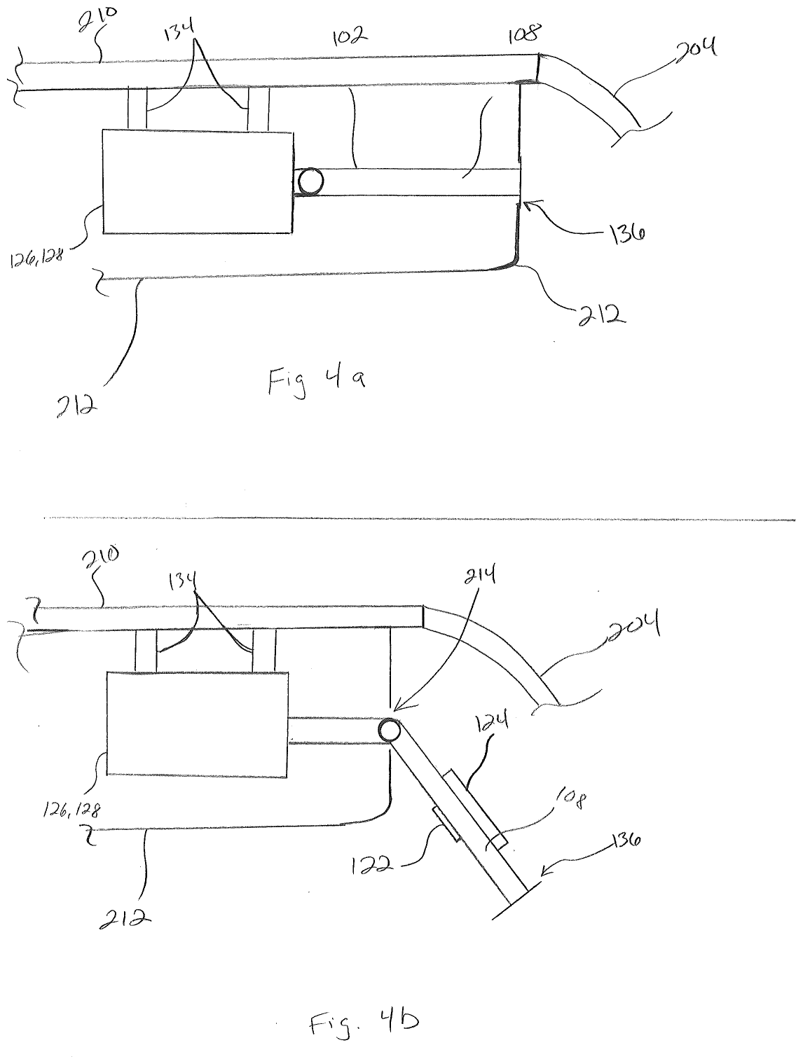

In some embodiments, the screen 102 may be located adjacent to the windshield 204 as shown in FIGS. 3a and 3b. It will be understood that a motor vehicle generally includes an interior compartment 206 that is separated from the exterior environment 208 by the windshield 204. As shown in FIG. 4b, some embodiments may include a screen having an interior-facing surface 118 and an exterior-facing surface 120. The interior-facing surface 118 may include a reflective panel 122, such as a mirror or similar panel, disposed about the interior-facing surface 118 and directed at the occupant of the motor vehicle. In some embodiments, the reflective panel 122 may be independently adjustable in relation to the screen 102. If the screen 102 is at an ideal angle to block sun radiation 200 from the occupant, but is not at an ideal angle for the occupant to see the reflective panel 122 as desired, then the reflective panel 122 may be adjusted independently of the screen 102 so that both the screen 102 and reflective panel 122 may be at ideal angles to the occupant at the same time.

In some embodiments, the exterior-facing surface 120 may include a solar panel 124 which can capture solar radiation 200. The solar panel 124 may be used to charge and/or store solar power for use by the motor vehicle or for use by an auxiliary power supply.

Referring now to FIGS. 2-4, in some embodiments, an actuator 126 may be connected to the intermediate member 110. It will be understood that a single actuator or a plurality of actuators may be connected to drive the frame 104 from a fully retracted position to a fully deployed position. One of skill in the art will understand that any reference to a single actuator in this disclosure may be applicable to a plurality of actuators for the same disclosure.

As shown in FIG. 2, in some embodiments, the actuator 126 may be fixedly connected to the intermediate member 110. In other embodiments, the actuator 126 may be rotatably connected to the intermediate member 110. The rotation of the intermediate member 110 may occur along the intermediate member's longitudinal axis β as shown in FIG. 2. This rotation may allow for the screen 102 to be selectively positioned at a given angle desired by the occupant of the motor vehicle. The intermediate member 110 and actuator 126 may be connected via a rotating pin joint, pin and slot joint, bushing and retainer mechanism, a bearing mechanism, or the like. One of skill in the art will readily understand that various rotatable mechanisms may be employed to allow rotation of the intermediate member 110 to rotate about its longitudinal axis β in relation to the actuator 126 connection point. In some embodiments as depicted in FIG. 2, two actuators 126, 126 may be connected to the intermediate member 110.

In some embodiments, the actuator 126 may be configured to operably drive the screen 102 and frame 104 between a fully retracted position (FIG. 3a) and a fully deployed position (FIG. 3b). In some embodiments, the actuator 126 may be configured to selectively position the screen 102 and frame 104 at an intermediate position between the fully retracted position and fully deployed position. This selective intermediate position may allow an occupant to deploy the screen 102 to a position only as far as needed or intended. In some embodiments, the screen 102 and frame 104 may be deployed incrementally such that the screen 102 may be positioned at any point between the fully retracted position and fully deployed position. This configuration may be advantageous in allowing the screen 102 and frame 104 to be effectively utilized and adaptable to a variety of occupants based on their height relative to the roof while sitting, or their general preference of the screen's position.

The actuator 126 of the present disclosure may be any appropriate actuator including, but not limited to, manual, pneumatic, hydraulic, or electric actuators. In some embodiments, the actuator 126 may include a linear actuator which may be operably connected to the frame 104 and screen. In some embodiments, the actuator 126 may be a lead-screw actuator. The actuator 126 may be in electrical communication with an on-board power source 130 of the motor vehicle, such as the 12-volt power supply. In some embodiments, the actuator 126 may be in electrical communication with a power source 130 that is separate from the motor vehicle. In some embodiments, the separate power source 130 may be battery supplied separate from the motor vehicle battery system.

As shown in FIG. 2, the electrical power source 130 may be configured through a switch 132 that can be controlled by the occupant of the motor vehicle. The switch 132 may be located within the interior compartment 206 of the motor vehicle, including on the dashboard, steering wheel, door panel, or arm rest. The switch may be interconnected to the actuator 126 and the power source 130 via electrical wiring to supply the system 100 with appropriate power. In some embodiments, a control unit may be included and may be comprised of a microprocessor or the like and other necessary electronics that will control the power supply to the system 100 as necessary. The switch 132 may include any conventional switch such as a single pole double throw switch. In some embodiments, the motor vehicle may already include a switch or button that can be utilized with the system 100 as disclosed herein.

In some embodiments, the switch 132 may be pressed in a first direction which will deploy the actuator 126 to drive the screen 102 and frame 104 until the switch is either relieved from pressure or the actuator reaches the further deployment position. The switch 132 may be pressed in a second direction which will retract the actuator 126 to drive the screen 102 and frame 104 until the switch is either relieved from pressure or the actuator retracts the screen 102 and frame 104 to its fully retracted position.

As shown in FIGS. 3 and 4, a mount 134 may be connected to the actuator 126. The mount may be configured to be mounted to the roof 210 of the motor vehicle. In some embodiments, the system 100 may be disposed between the roof 210 and the headliner 212. The mount 134 may be any appropriate mounting system for securing the actuator 126 in a fixed position. In some embodiments, the mount 134 may include an ear, flange, projection, or the like which allows the mount to be secured via rivet, nut and bolt, bolt, screw, and the like. In some embodiments, a magnet or similar may be utilized to attach the actuator to the roof. This may be beneficial in a motor vehicle that is being retrofitted with the system 100 and does not have other provisions for attaching the mount.

In some embodiments, the screen 102 may include a leading edge 136. The leading edge 136 may be positioned such that when the screen 102 is fully retracted between the roof 210 and headliner 212, the leading edge 136 is seated flush with the headliner 212. Such an embodiment may allow for the remaining portions of the screen 102 and frame 104 to be non-visible to the occupant of the motor vehicle. During deployment, the actuator 126 may drive the screen 102 and frame 104 from an opening 214 of the headliner and then similarly, may retract the screen 102 and frame 104 back into the opening 214 of the headliner until the leading edge 136 is seated flush against the headliner 212.

The foregoing descriptions of specific embodiments of the present invention have been presented for the purposes of illustration and description. They are not intended to be exhaustive or to limit the invention to the precise forms disclosed herein. Many modifications and variations may be possible in light of the above teachings to those skilled in the art. The chosen and detailed embodiments as described herein provide disclosure to one of skill in the art so that it may be understood and have practical application.

What is claimed is:

1. A sunshade apparatus for a motor vehicle comprising:
a frame, having a first rigid member and a second rigid member, an intermediate member rotatably connected to the first rigid member and second rigid member;
a screen disposed between the first rigid member and second rigid member;
an actuator wherein the intermediate member is fixedly connected to the actuator and the actuator operably driving the frame and screen, wherein the frame and screen is selectively and incrementally positionable between a fully deployed position and a fully retracted position.

2. The sunshade apparatus of claim 1, wherein the intermediate member further comprises a first end and a second end, the first rigid member being closer to the first end than the second end and the second rigid member being closer to the second end than the first end.

3. The sunshade apparatus of claim 1, wherein the intermediate member further comprises an axis along its length and a rotating pin and slot for rotating the first and second rigid members about the axis.

4. The sunshade apparatus of claim 1, further comprising a motor operably connected to the actuator and in electrical communication with an on-board electrical power source of the motor vehicle.

5. The sunshade apparatus of claim 1, wherein the actuator comprises a plurality of actuators, each actuator of the plurality of actuators fixedly connected to the intermediate member.

6. The sunshade apparatus of claim 1, wherein the screen is opaque.

7. The sunshade apparatus of claim 1, wherein the screen is semi-transparent.

8. The sunshade apparatus of claim 1, wherein the screen further comprises an interior-facing surface and exterior-facing surface, the interior-facing surface including a reflective panel.

9. The sunshade apparatus of claim 1, wherein the screen further comprises an interior-facing surface and exterior-facing surface, the exterior-facing surface including a solar panel.

10. The sunshade apparatus of claim 1, further comprising a mount connected to the actuator and configured to be mounted to the roof of the motor vehicle, the apparatus being disposed between the roof of the motor vehicle and a headliner, and
the screen comprising a leading edge wherein in the fully retracted position, the leading edge is seated flush with the headliner and the remaining screen is non-visible between the roof and headliner.

11. A sunshade apparatus for a motor vehicle comprising:
a screen connected to a first member and a second member;
an intermediate member connected to the first member and the second member,
an actuator connected to the intermediate member, the intermediate member being rotatable about the actuator connection wherein the actuator is configured to selectively and incrementally move the intermediate member between a fully deployed position and a fully retracted position.

12. The sunshade apparatus of claim 11, wherein the intermediate member further comprises a first end and a second end, the first member being closer to the first end than the second end and the second member being closer to the second end than the first end.

13. The sunshade apparatus of claim 12, wherein the intermediate member is connected to the actuator via a rotating pin and slot.

14. The sunshade apparatus of claim 13, further comprising a motor operably connected to the actuator and in electrical communication with an electric power source separate from an electrical power source of the motor vehicle.

15. The sunshade apparatus of claim 11, wherein the actuator comprises a plurality of actuators, each actuator of the plurality of actuators rotatably connected to the intermediate member.

16. The sunshade apparatus of claim 11, wherein the screen is opaque.

17. The sunshade apparatus of claim 11, wherein the screen is semi-transparent.

18. The sunshade apparatus of claim 11, wherein the screen further comprises an interior-facing surface and exterior-facing surface, the interior-facing surface including a reflective panel.

19. The sunshade apparatus of claim 11, wherein the screen further comprises an interior-facing surface and exterior-facing surface, the exterior-facing surface including a solar panel.

20. The sunshade apparatus of claim 11, further comprising a mount connected to the actuator and configured to be mounted to the roof of the motor vehicle, the apparatus being disposed between the roof of the motor vehicle and a headliner, and
the screen comprising a leading edge wherein in the fully retracted position, the leading edge is seated flush with the headliner and the remaining screen is non-visible between the roof and headliner.
